(19) United States
(12) Patent Application Publication
(10) Pub. No.: US 2025/0347563 A1
(43) Pub. Date: Nov. 13, 2025

(54) High Detectivity Infrared and Terahertz Radiation Sensing Using Frequency-Noise-Optimized Nanomechanical Resonators

(71) Applicant: University of Ottawa, Ottawa (CA)

(72) Inventors: Raphael St-Gelais, Ottawa (CA); Chang Zhang, Ottawa (CA); Mathieu Giroux, Gatineau (CA); Jean-Michel Ménard, Ottawa (CA)

(21) Appl. No.: 19/204,107

(22) Filed: May 9, 2025

Related U.S. Application Data
(60) Provisional application No. 63/645,621, filed on May 10, 2024.

(51) Int. Cl. G01J 5/06; G01J 5/02; G01J 5/0821; G01J 5/20

(52) U.S. Cl. CPC G01J 5/06; G01J 5/0205; G01J 5/0821; G01J 5/20

(57) ABSTRACT

A high detectivity infrared and terahertz sensing using a silicon nitride (SiN) nanomechanical resonator functionalized with an optical absorber. The membrane resonator is actuated by a piezo actuator and interrogated by an interrogation laser to determine the intensity of an incident light source. High performances are achieved by striking a fine balance between the frequency stability of the resonator, and its responsivity to absorbed radiation.

### CROSS-REFERENCE TO RELATED APPLICATIONS

The present application is a non-provisional application of U.S. Provisional Patent Application No. 63/645,621 filed May 10, 2024, the entirety of which is incorporated for all purposes.

### TECHNICAL FIELD

The present disclosure relates to radiation sensors and in particular to infrared and terahertz radiation sensors using nanomechanical resonators.

### BACKGROUND

Although thermal-based sensors have been used for decades for incoherent long-wavelength (infrared and terahertz) detection, their performance still falls significantly short of the fundamental detectivity limit imposed by thermal fluctuation noise (D*=1.8×10¹⁰ cm·\sqrt{Hz}/W). This performance gap largely comes from electrical Johnson noise in their electrical readout, resulting from non-negligible electrical resistance. In recent years, temperature-sensitive nanomechanical resonators have been proposed as a promising alternative to replace traditional thermal-based sensors due to their immunity to such electrical Johnson noise. Resonators made of thin-film materials e.g., silicon nitride (SiN), aluminum nitride (AIN), graphene, gallium arsenide (GaAs) have been investigated extensively for thermal-based radiation sensing at infrared wavelengths. Utilizing similar thermal-based sensing approach, resonators coated with additional metal absorbers have been proposed for detection at THz (0.25-3 THz) and sub-THz (0.1-0.3 THz) frequencies.

A common approach for optimizing performances in these nanomechanical sensors is by maximizing the magnitude of the mechanical resonance frequency shift relative to optical power absorption (i.e., maximizing thermal responsivity R). This is typically done by utilizing resonators of very small size (i.e., effective side length from 10¹ μm to 10² μm) and by thermally isolating them via extremely thin supporting structures (e.g., tether, rod, etc). Surprisingly, resonators frequency instability [symbol] δf/fᵣ [symbol] is typically not as central to the design process as responsivity R, even though it is equally important to the determination of the final noise figure.

Considering recent studies on frequency noise in nanomechanical resonators, approaches for improving the responsivity R, such as extreme size miniaturization and thermal isolation enhancement, can also significantly degrade resonators frequency stability and hence the overall sensing performance. As a result, the specific detectivity D* of recently reported resonator-based THz and sub-THz detectors still falls short of the best commercial room-temperature, on-chip THz detectors (i.e., pyroelectric detectors with D*˜7×10⁸ cm·\sqrt{Hz}/W) by factors 68 and 2, respectively. Likewise, their performances are at least one order of magnitude below those of a typical Golay cell (D*˜4×10⁹ cm ·\sqrt{Hz}/W).

Accordingly, systems and methods that enable improved terahertz radiation sensing using frequency-noise-optimized nanomechanical resonators remains highly desirable.

### SUMMARY

One general aspect includes a high detectivity infrared and terahertz radiation sensor. The high detectivity also includes a vacuum chamber having a view port on a first surface; a membrane resonator assembly mounted inside the vacuum chamber on an second surface opposite the first surface; and an optical fiber entering the vacuum chamber via the second surface facing towards a front surface of the membrane resonator assembly, the optical fiber coupled to a laser interferometer; where a rear surface of the membrane resonator assembly receives infrared or terahertz radiation incident light passing through the view port and is measured by the laser interferometer on the front surface of the membrane resonator assembly to determine the radiation intensity of the incident light. Other embodiments of this aspect include corresponding computer systems, apparatus, and computer programs recorded on one or more computer storage devices, each configured to perform the actions of the methods.

Implementations may include one or more of the following features. The system where the membrane resonator assembly may include an SiN membrane resonator. The membrane resonator assembly contains a trampoline structure resonator. The SiN membrane resonator has a layer of sputtered Au-Pd deposited thereon. The Au-Pd is deposited on the sin membrane in a circular pattern. The sin membrance may include a metasurface having an array of cross absorber pattern on the membrane. The metasurface is formed by depositing titanium onto the SiN membrane resonator via electron beam evaporation through a shadow mask to form the metasurface. The system where in the viewport is zinc selenide (ZnSe). The membrane resonator assembly is mounted inside the vacuum chamber by a flange coupled to the vacuum chamber, the membrane resonator assembly may include: a membrane chip containing a membrane resonator thereon; a bottom plate coupled having a cavity for receiving a membrane chip; a top plate for containing the membrane chip within the bottom plate; where the rear surface of the membrane resonator is directed towards the top plate and the front surface of the membrane is directed towards the bottom plate and the optical fiber. The system where the bottom plate and the top plate have a plurality of corresponding pillars to retain the membrane carrier therein. The top plate is flexible, enabling a low mounting force not to create excessive stress on the membrane chip. The optical fiber enters through an opening in the flange interfacing by a PC ferrule. The PC ferrule is retained by an a high-temperature optical fiber epoxy. The PC ferrule is glued in place to form a small Fabry-Pérot optical cavity when assembled with the membrane resonator cavity.

One general aspect includes the system where 3 pillars are provided in the bottom plate and correspond to 3 pillars in the top plate. One general aspect includes a method of an infrared and terahertz radiation sensing. The method also includes actuating a membrane resonator by a piezo actuator coupled to the membrane resonator mounted inside a vacuum chamber having a view port onto a rear surface of the membrane resonator, the rear surface receiving an incident light source; interrogating the membrane resonator by an optical fiber entering the vacuum chamber towards a front surface of the membrane resonator providing a fixed light source, measuring the frequency of a received signal from fixed light source from the front surface of the membrane resonator, measuring resonance frequency variation due to incoming radiation, and estimating the power of the incident light source by tracking the variation of the membrane resonance frequency compared to a frequency reference.

Implementations may include one or more of the following features. The method may include, adjusting a piezo actuator coupled to the membrane resonator assembly to achieve a predetermined drive amplitude, and calibrating the sensor system by tracking the resonator's baseline frequency prior to exposure to the radiation beam. The method may include, regulating the pressure inside the vacuum chamber to reduce damping and convective heat transfer, stabilizing the membrane resonator's temperature, and thereby minimizing noise for enhanced detection accuracy. The method may include, determining a noise equivalent power of the sensor by measuring resonator frequency instability without incident radiation, dividing by the responsivity of the sensor, and thereby establishing the minimum detectable radiation power. The membrane resonator assembly and the optical fiber interface form a Fabry-Pérot optical cavity.

### BRIEF DESCRIPTION OF THE DRAWINGS

Further features and advantages of the present disclosure will become apparent from the following detailed description, taken in combination with the appended drawings, in which:

FIG. 1. shows a representation of (a) Thermal responsivity of fractional frequency shifts for square SiN membranes of various lengths; (b) Theoretical Allan deviations σ_A of two SiN membranes with significantly different side lengths; (c) Noise equivalent power (NEP) of SiN membranes of various side lengths; (d) Specific detectivity D\hat{ }*=L/NEP of SiN membrane resonators;

FIG. 2. shows a representation of (a) Numerically computed thermal responsivity R of a D=1 mm diameter localized THz metasurface absorber; (b) Numerically computed absorption spectrum of the fabricated metasurface in the THz frequency range;

FIG. 3. shows a system for high detectivity terahertz radiation sensing;

FIG. 4. shows (a) Fractional frequency shift δf/fᵣ time trace upon terahertz absorption at 2 Hz optical modulation and filtered at phase-lock loop (PLL) bandwidth of 8 Hz; (b) δf/fᵣ amplitude at various optical modulation frequencies; (c) Normalized GaP emission power spectrum matched with simulated absorption power spectrum of the Ti metasurface; (d) Noise equivalent power (NEP) of the device at different drive amplitudes, calculated from Allan deviation σ_{A} and thermal responsivity R;

FIG. 5. shows (a) Comparison between a commercial Golay cell signal and SiN membrane resonator frequency shift signal δf. (b) SiN membrane resonator frequency shift signal δf as a function of incident power retrieved from (a);

FIG. 6. shows fractional frequency shift δf/fᵣ time trace of the SiN membrane resonator at various levels of attenuated incoming THz power;

FIG. 7 shows a method of high detectivity terahertz radiation sensing. It will be noted that throughout the appended drawings, like features are identified by like reference numerals;

FIG. 8 show a system for high detectivity infrared and terahertz radiation sensing using frequency-noise-optimized nanomechanical resonators;

FIG. 9 shows a membrane resonator chip;

FIG. 10 show a membrane resonator;

FIG. 11 shows a flange providing an optical fiber feedthrough to the resonator;

FIG. 12 shows a flange providing an optical fiber feedthrough to the resonator without a resonator mounting top plate;

FIG. 13 shows a bottom view of the flange;

FIG. 14 shows a membrane mounting plate;

FIG. 15 shows a side view of an assembled configuration of the membrane mounting;

FIG. 16 shows an expanded side view of the membrane mounting;

FIG. 17 shows an expanded side view as shown from a top edge of the membrane mounting plate;

FIG. 18 shows cross-sectional side view of the membrane resonator assembly;

FIG. 19 shows cross-sectional perspective view membrane resonator assembly;

FIG. 20 shows enlarged cross-sectional perspective view of the membrane and optical fiber interface; and

FIG. 21 shows a plot of absorption times for Au-Pd on the membrane.

### DETAILED DESCRIPTION

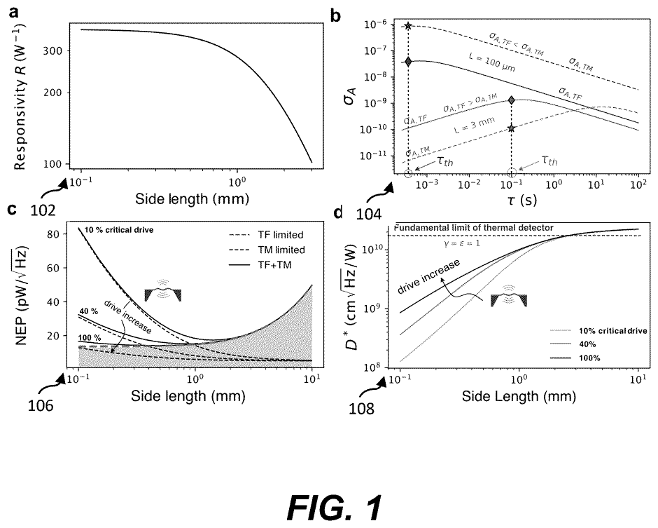

Embodiments are described below, by way of example only, with reference to FIGS. 1-21.

Maximizing responsivity by miniaturization can be a counterproductive sensor design approach, and that greater detection performance gains can be realized via minimizing frequency instability [symbol] δf/fᵣ [symbol] using a resonator of relatively large mass. By striking a balance between responsivity and frequency stability, an ultrasensitive uncooled THz detector with NEP≈36 pW/\sqrt{Hz} and specific detectivity D*≈3.4×10⁹ cm·\sqrt{Hz}/W at 2 THz incident radiation frequency is provided. The disclosed system and method therefore exhibits two orders of magnitude improvement in D* compared with resonator-based detectors operating in THz frequency range and a factor of 5 improvement in D* compared with the highest performance commercial room-temperature, on-chip THz detectors.

The optimization of some important parameters of a square SiN membrane resonator for thermal-based detection (i.e., at any incident wavelength) are provided. For this purpose, noise equivalent power is defined as:

$$NEP = \frac{δ f / {f}_{r}}{R} , \qquad ( 1 )$$

where R is the sensor responsivity to incident power (in W⁻¹), [symbol] δf/fᵣ [symbol] is resonator fractional frequency instability spectrum (in Hz^{-1/2}) for a given eigenmode of frequency fᵣ.

The contribution to NEP of R, is optimized for smaller membranes, but only with modest gains at sub-mm dimensions. The responsivity R can be estimated theoretically as R=γα/G, where γ is the absorption coefficient at a specific detection wavelength (e.g., γ=0.4 at 2 THz in this work), α is the temperature coefficient of fractional frequency shifts (in K⁻¹), and G (in W/K) is the total thermal conductance between the resonator and its environment. G is calculated using a closed-form heat transfer model that depends on the resonator dimensions (side length L, thickness t), on the material thermal conductivity (k=2.7 W/m·K) and on the membrane hemispherical total emissivity ε of approximately 0.11 for plain 90-nm-thick SiN. In turn, for the first few mechanical modes, α is well approximated by:

$$α ≅ \frac{E {α}_{T}}{2 σ ( 1 - v )} , \qquad ( 2 )$$

where E=300 GPa is Young's modulus, α_{T}=2.2×10⁻⁶K⁻¹ is the membrane material thermal expansion coefficient, σ=100 MPa is the built-in tensile stress, and v=0.28 is the Poisson ratio. For higher order modes, Eq. (2) generally yields an error of less than 20%. Thus, for a given set of material constants, R essentially depends on G, which is linked to the resonator dimensions. As shown in FIG. 1(a), minimizing L increases the membrane responsivity by reducing thermal radiation heat transfer with the environment. However, such improvement gradually plateaus for sub-mm values of L, when G becomes strongly dependent on solid-state conduction and weakly dependent on L.

In contrast, membrane resonators with larger dimensions (i.e., L>1 mm) exhibit significant gains in terms of minimizing frequency instability [symbol] δf/fᵣ [symbol] . To understand the intrinsic noises of these resonators theoretical Allan deviation σ_{A} is computed from expected fractional frequency noise spectral density S_{y}(ω). This includes thermomechanical S_{y,TM}(ω) and thermal fluctuation S_{y,TF}(ω) noises. Thermomechanical noise is given by:

$${S}_{y , TM} ( ω ) = \frac{{k}_{B} T}{8 {π}^{3} {m}_{eff} {f}_{r}^{3} {QA}_{rss}^{2}} \cdot {\vert \frac{1}{1 + j {ωτ}_{mech}} \vert}^{2} , \qquad ( 3 )$$

where k_{B} is the Boltzmann constant, T is the background environment temperature, m_{eff} is the resonator effective mass, Aᵣₛₛ is the driven oscillation amplitude, τ_{mech}=Q/πfᵣ is mechanical time constant of the resonator, and Q is the mechanical quality factor at eigenfrequency fᵣ. In turn, thermal fluctuation noise is given by:

$${S}_{y , TF} ( ω ) = \frac{2 {k}_{B} {T}^{2} {α}^{2}}{π G} \cdot {\vert \frac{1}{1 + j {ωτ}_{th}} \vert}^{2} , \qquad ( 4 )$$

where τₜₕ is the resonators thermal time constant accounting for radiative and thermal coupling.

FIG. 1. shows (a) representation 102 is of thermal responsivity of fractional frequency shifts for square SiN membranes of various lengths L, and a fixed thickness of 90 nm. (b) representation 104 is of theoretical Allan deviations σ_{A} of two SiN membranes with significantly different side lengths (L=3 mm & L=100 μm), considering thermomechanical noise σ_{A,TM} (dashed lines) and thermal fluctuation noise σ_{A,TF} (solid lines). (c) representation 106 is of noise equivalent power (NEP) of SiN membranes of various side lengths L with fixed thickness of 90 nm, considering thermomechanical (TM) and thermal fluctuation (TF) noise. Three sets of traces represent NEP of resonator at different driven vibration amplitudes. (d) is a representation 108 of specific detectivity D*=L/NEP of SiN membrane resonators considering both thermomechanical and thermal fluctuation noises at different vibration amplitudes. All calculations consider a total emissivity of ε=0.11 and absorption γ=0.4 at the detection frequency (˜2 THz in this work).

In FIG. 1(b), as an example, the theoretical GA is computed of a 90-nm-thick SiN membrane resonator of significantly different sizes (i.e., L=1 mm, and L=100 μm), considering the resonator is actuated at mode (1,1) at an arbitrary low drive amplitude (i.e., 10% of the critical drive given by A_{crit}=L\sqrt{σ/QE}. m_{eff}, fr, Q, A_{crit} and G are scaled accordingly to the dimension L, from which Q=10⁴ and 10⁶ are considered for membranes of L=100 μm and 1 mm. In the large membrane, τ_{mech}>>τₜₕ is obtained such that thermomechanical noise (σ_{A,TM}) is significantly filtered (i.e., attenuated) when sampling at the resonator thermal time constant τₜₕ, i.e., when sampling as fast as the membrane can thermally respond (τₜₕ=100 ms). This is not the case for the smaller membrane, in which thermomechanical noise is a dominant noise source that adds to fundamental temperature fluctuations. As a result, at τₜₕ=100 ms, the total noise in the large membrane (σ_{A}≈σ_{A,TF}=2×10⁻⁹) is two orders of magnitude lower than in the small membrane (σ_{A}≈σ_{A,TM}=2×10⁻⁷).

Finally, a balance is struck between optimizing responsivity R and frequency instability [symbol] δf/fᵣ [symbol] , from which the optimal resonator dimensions are on the order of 1 mm. FIG. 1(c) presents a more comprehensive view on resonators NEP over a range of commonly used sizes (i.e., L=100 μm to 10 mm). In this case NEP is calculated as σ_{A}·\sqrt{τₜₕ}/R. NEP deteriorates at both extreme large and small L. As L becomes smaller than 1 mm, NEP is harmed by excessive level of thermomechanical noise (see Eq. 3). Conversely, as L gets exceedingly large (i.e., L>3 mm), NEP is affected by diminishing R (see FIG. 1a). Consequently, as shown in FIG. 1(c), NEP is inherently optimal within the range 1 mm<L<3 mm.

In practical settings, the smallest detectable radiation intensity (in W/m²) is sometimes a more important metric than the smallest measurable power (in W). In FIG. 1(d), the NEP values are normalized presented in FIG. 1 by their corresponding membrane dimension L to obtain specific detectivity (D*=L/NEP). When L<1 mm, D* degrades quickly to below the fundamental limit of thermal-based detector [1,15] due to thermomechanical noise. For large membranes (L>3 mm), D* approaches, and slightly exceeds this fundamental limit. This overcoming of the fundamental detectivity limit is possible due to a departure from the blackbody radiation assumption. In this case the peak THz absorption (γₚₑₐₖ=0.4 due to an absorptive metasurface) is higher than the emissivity at thermal wavelength (ε=0.11), thus allowing this discrepancy.

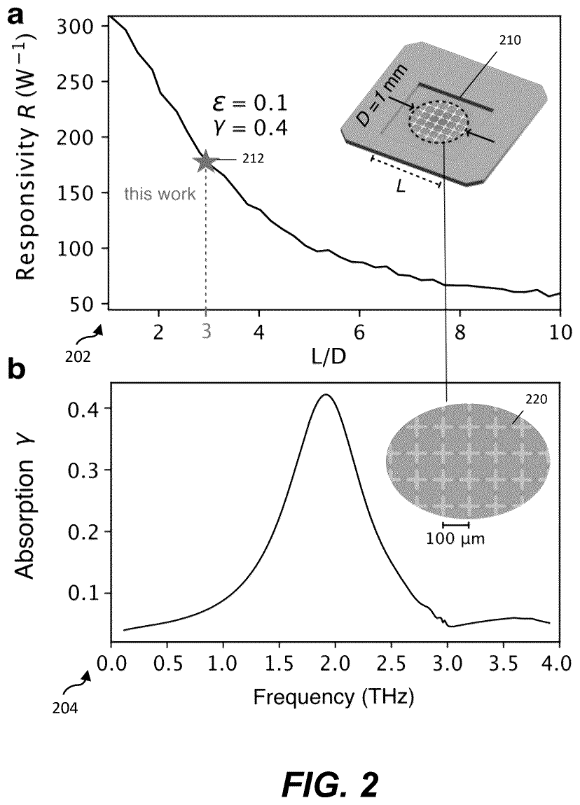

FIG. 2. shows (a) representation 202 of a numerically computed thermal responsivity R of a D=1 mm diameter localized THz metasurface absorber 210 incorporated on top of SiN membrane resonators of various side lengths L. The star 212 indicates the responsivity of the fabricated device. (b) representation 204 of numerically computed absorption spectrum of the fabricated metasurface in the THz frequency range. Inset: microscope photograph of the fabricated metasurface 220.

In an embodiment a relatively large 3.2×3.2 mm square SiN membrane resonator is used as the sensing platform, which we functionalize with a 70-nm-thick titanium metasurface to enable THz absorption. The THz absorption spectrum of the metasurface is designed using finite-difference-time-domain (FDTD) simulation software, from which a peak γₚₑₐₖ=0.4 at ˜2 THz, as shown in FIG. 2(a). The metasurface is deposited with a 1 mm effective diameter D at the center of the membrane 210 (see FIG. 2a) to ensure a sufficiently large peripheral area of plain SiN for optomechanical interrogation. This metal-free region prevents the interrogation laser source (i.e., a 1564 nm distributed feedback laser) from impinging onto the titanium metasurfaces and causing spurious heating.

By covering only part of the membrane resonator, responsivity calculation is adjusted from those of a uniform membrane in FIG. 1(a). A combined modes heat equation (i.e., coupled radiation and conduction) of the SiN membrane resonator is solved by defining a heating zone at the geometric center of the membrane, which accounts for the effective localized heating area (i.e., effective diameter of the titanium metasurface D). FIG. 2(b) exhibits the variation in R when a D=1 mm localized titanium metasurface incorporated at the geometric center of a SiN membrane resonator at different sizes L. This approach (i.e., D=L/3=1 mm) sacrifices ˜40% of R, compared with a uniformly heated (i.e., D=L=3 mm) SiN membrane resonator.

The plain SiN membrane resonator can be fabricated using a 90-nm-thick low-pressure chemical vapor deposition (LPCVD) low-stress SiN-on-silicon wafer. The titanium is deposited onto the surface of the SiN membrane resonator via electron beam evaporation through a custom-made shadow mask to form the metasurface.

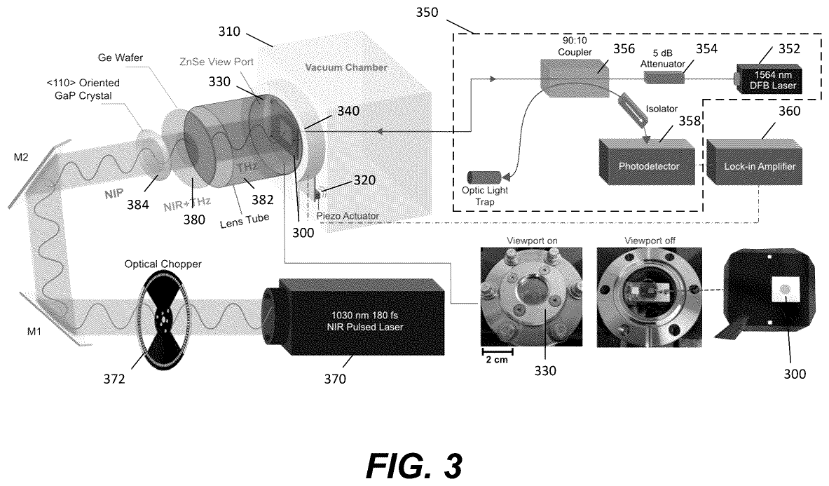

With reference to FIG. 3, once fabricated, the resonator 300 is placed in a portable high vacuum (˜10⁻⁶ hPa) chamber 310 to minimize convective heat transfer and damping by air. The resonator can be mounted on a steel plate by three pairs of disc magnets, although alternative clamping methods may be utilized while minimizing contact surface, and mechanically excited via a piezo actuator 320. The membrane is aligned with the center of a zinc selenide (ZnSe) view port 330 for easy optical alignment as shown in FIG. 3. A single-mode optical fiber tip 340 is pointed at the back side of the resonator for optical interrogation of its mechanical vibration. A vibration signal of the resonator is probed using a laser interferometer 350 located outside the vacuum chamber and consisting of a 1564 nm distributed feedback (DFB) laser 352, a 5 dB optical attenuator 354, a coupler 356, for example 90:10, and a photodetector 358. The combined use of the optical attenuator 354 and coupler 356 reduces the laser power, for example to just 11.7 μW, before reaching the SiN membrane resonator 300. This largely attenuated laser power produces sufficient signal for detection, while preventing any noticeable laser heating during interrogation.

In an embodiment an MFLI lock-in amplifier (LIA) 360 is utilized to excite our sample at a high Q-factor (Q=870,000) mechanical eigenmode (i.e., mode order 2,3 at 124 kHz in this case) and track its resonance frequency shift upon THz light absorption via a built-in phase-locked loop (PLL) frequency tracking function. The demodulation bandwidth (5 kHz), and sampling rate (32,000 Sa/S) are both set to very high values, which we can numerically average to lower effective sampling rates in postprocessing. The PLL bandwidth is set to 8 Hz, which ensures that the PLL tracking speed is roughly five times faster than the thermal time constant (τₜₕ≈100 ms) of a plain 3.2×3.2 mm SiN membrane, such that the true thermal response (τₜₕ) of the SiN membrane resonator can be recorded without filtering.

Collimated THz radiation is generated with spectrum centered around 1.8 THz via optical rectification of a collimated near-infrared (NIR) pulsed laser beam 370 (1 mJ pulse energy, 180 fs pulse duration, 6 kHz pulse repetition rate) in a 2-mm-thick <110>-oriented gallium phosphide (GaP) crystal (see FIG. 3). The generated THz radiation is pulsed with the same repetition rate but is perceived as CW by the sensor of comparatively slow response time (τ=200 ms). A germanium (Ge) wafer 380 that is transparent to THz radiation is placed in the optical path (see FIG. 3) to block the residual NIR light, ensuring that only the THz light can reach the SiN membrane resonator. Additionally, a 20-cm long, circular hollow lens tube 382 is optionally positioned between the Ge wafer 380 and the ZnSe viewport 330 of the portable vacuum chamber 300, to prevent any possible external stray light from reaching the sample. This relatively long (20 cm) propagation length also geometrically attenuates, via divergence, parasitic thermal radiation generated in the Ge wafer 380 due to NIR absorption, while the coherent THz beam remains collimated to an approximately constant diameter (6 mm).

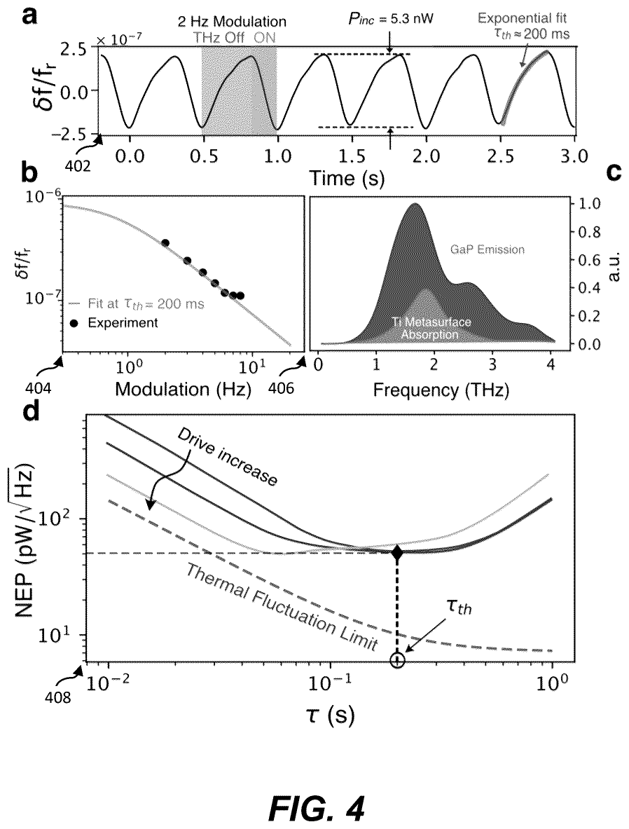

The heat transfer model in the resonators can be validated by recording the fractional mechanical frequency shifts δf/fᵣ when exposed to a 6-mm-diameter THz beam, modulated at 2 Hz via an optical chopper 372. This is shown in FIG. 4(a), in which the effective sampling rate is set to match the PLL bandwidth (8 Hz). From this figure, a thermal response time τₜₕ≈200 ms is obtained that is roughly two times larger than the expected τₜₕ of a plain SiN membrane. This shows the reduced response speed due to THz absorption occurring in a localized region, and the additional thermal mass of the titanium metastructures. This can then be repeated at different optical modulation frequencies (from 2 Hz to 8 Hz), from which the expected frequency roll-off a 1-pole low pass filter of thermal time constant τₜₕ is obtained (see 404 FIG. 4b).

The effective optical absorption (γeff≈27%) is measured of the metasurface for the specific THz source, which allows extraction of the sensor responsivity. Electron optical sampling (EOS) is performed to measure the THz emission power spectrum generated by non-linear conversion in the GaP crystal 384 (see FIG. 4c,). This emission spectrum is compared to the absorption spectrum of the metasurface (see FIG. 2b). This comparison is shown in FIG. 4(c), from which it can be inferred that the metasurfaces absorbs γ_{eff}≈27% of the incident THz light for the source in this example (i.e., for a source frequency spanning from 0.5 THz to 4 THz, see 406 FIG. 4c). This is different than the peak absorption of γₚₑₐₖ≈40% at designed frequency (2 THz in FIG. 2b). The predicted responsivity is adjusted by 33% from the value predicted in FIG. 2(a), i.e., we use R≈120 W⁻¹ in the following.

Using this responsivity, the measured fractional frequency shift δf/fᵣ in FIG. 4(a) can be related to the THz power incident on our metasurface using

$${P}_{inc} = \frac{δ f / {f}_{r}}{R \vert \frac{1}{1 + j {ωτ}_{th}} \vert} . \qquad ( 5 )$$

This yields an incident power of 5.3 nW as indicated in plot 402 of FIG. 4(a). Likewise, we can normalize this incident power by the area of the metasurface (πD²/4=0.79 mm²) to estimate the average intensity of the THz light to 6.7 nW/mm² at the metasurface location. It is estimated that ≈40% of the generated THz light transmits through the ZnSe viewport, such that the incident intensity prior to entering the vacuum chamber is ˜16.7 nW/mm².

Using this measured responsivity (R=120 W⁻¹), estimate of the detector NEP by measuring the Allan deviation noise trace (GA) in the absence of incident THz radiation, and then using NEP=σ_{A}·\sqrt{τ}/R. From this, plot 408 of FIG. 4(d) is obtained, which indicates a minimum NEP_{eff}≈51 pW/\sqrt{Hz} at a sampling time τₜₕ, for the specific broadband terahertz source spanning 0.5-4 THz. Correspondingly, NEPₚₑₐₖ≈36 pW/\sqrt{Hz} and D*≈3.4×10⁹ cm·\sqrt{Hz}/W is obtained at the central metasurface design wavelength (2 THz) where absorption is γₚₑₐₖ≈0.4. Such NEP is a factor of 5 larger than the fundamental limit imposed by thermal fluctuation noise (shown in FIG. 4d).

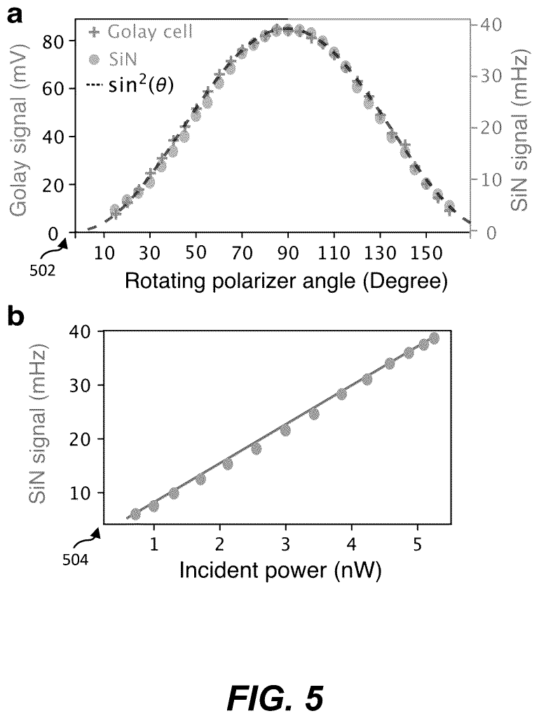

A metasurface thin-film polarizer can be used in front of the ZnSe viewport of the vacuum chamber for varying the intensity of the linearly polarized THz light. When rotating the polarizer away from the maximum transmission orientation by an angle θ, the transmitted THz power is expected to vary by a factor sin(θ)². This is recovered exactly in plot 502 of FIG. 5(a), for both the sensor and the control Golay cell. This exact correspondence with the Golay cell and the expected sin(θ)² signal attenuation confirms the linearity of the sensor, which is better illustrated by plotting the same measured SiN signal against the incident THz power in plot 504 of FIG. 5(b). It should be noted that the polarization sensitivity observed in FIG. 5 rules out the possibility that thermal light emitted from the NIR absorbing Germanium wafer is detected, which would be unpolarized.

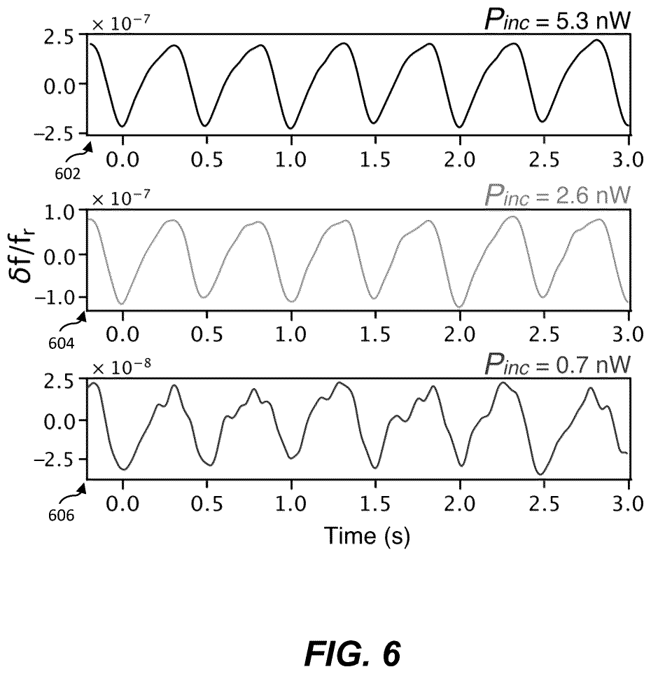

The same attenuation confirms the performance of the sensor at low optical power (5.3 nW in plot 602, 2.6 nW in plot 604, and 0.7 nW in plot 606). FIG. 6 presents the same response as in FIG. 4(a), but at different attenuation power (i.e., polarizer angle θ). The sensor can clearly detect optical power below 0.7 nW, as shown in plot 606, which was expected by our measured NEP_{eff}=51 pW/\sqrt{Hz} and data sampling rate of 8 Hz, from which the expected detection limit is 0.14 nW.

When noise sources are well estimated and designed-for, high performance radiation sensing at long optical wavelengths is possible using ubiquitous square SiN membrane resonators. Using localized terahertz metasurfaces absorbers, a peak detectivity of 3.4×10⁹ cm·\sqrt{Hz}/W at around 2 THz is provided. Such detectivity has not been previously realized by any existing nanomechanical resonator, nor by any commercial room-temperature on-chip terahertz detectors.

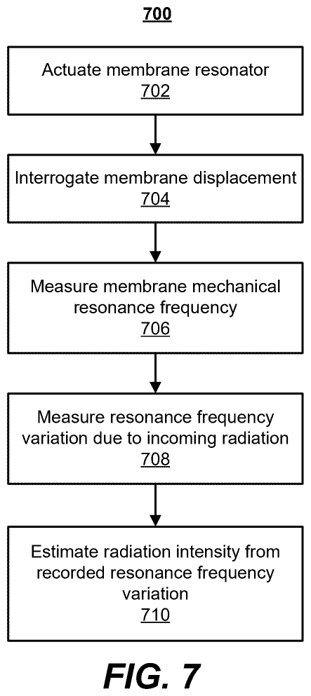

FIG. 7 shows a method of high detectivity terahertz and infrared radiation sensing. The pressure inside the vacuum chamber is lowered to lower the damping of the resonator and reduce convective heat transfer, stabilizing the membrane resonator's temperature and mechanical stability, and thereby minimizing noise for enhanced detection accuracy and providing higher resolution. The SiN membrane resonator comprising a metasurface (702) or a thin layer of Au-Pd (1000) is actuated to a driving amplitude reaching a critical amplitude. This critical amplitude is associated with material properties and geometry, not with frequency. The piezo actuator can be adjusted to achieve a predetermined drive amplitude, and further calibrate the sensor system by tracking the resonator's baseline frequency prior to exposure to the radiation beam. When using a high Q SiN membrane resonator, this critical amplitude scales with size of the membrane (side length). An interrogation laser is directed to the rear of the membrane (704), where an optical cavity is formed between the tip of the optical fiber (820) and the membrane or trampoline resonator (910). A received signal from the interrogation laser is measured (706) by a photodetector to determine the resonance frequency. From the received signal a frequency change of the membrane is measured (708). The variation of the resonator frequency provides an estimate (710) of the radiation intensity from the terahertz or infrared source. A polarizer may also be positioned in the path of the incident radiation to vary transmitted power, observing corresponding frequency changes in the resonator, and confirming linear response of the sensor system to incident power. A noise equivalent power of the sensor may be determined by measuring resonator frequency instability without incident radiation, dividing by the responsivity of the sensor, and thereby establishing the minimum detectable radiation power.

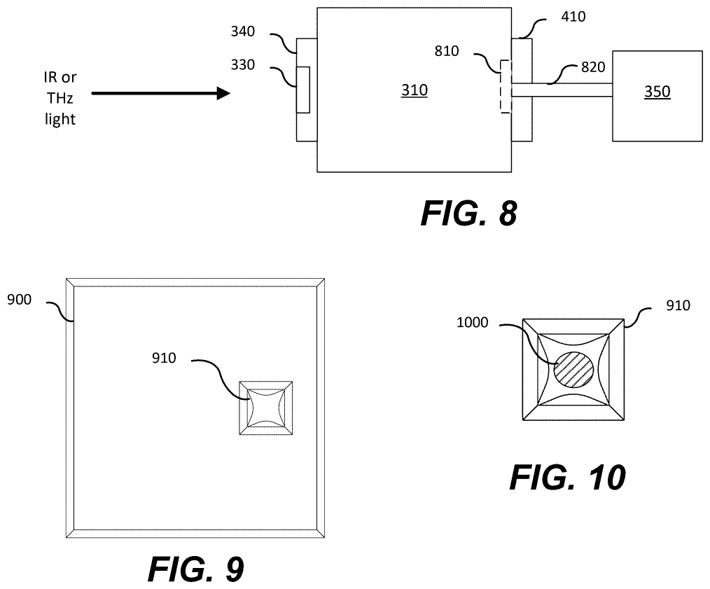

FIG. 8 show a system for high detectivity infrared and terahertz radiation sensing using frequency-noise-optimized nanomechanical resonators. The chamber 310 provides the membrane resonator assembly 810 coupled to flange 410. The resonator is coupled to a fiber cable 820 from laser interferometer 350 passing through the flange 410. The optical fiber cable 820 connects through a physical contact (PC) ferrule to the front surface of the membrane resonator assembly 810, creating a Fabry-Pérot interferometer cavity. Fabry-Pérot is an optical cavity formed by two parallel, partially reflective surfaces, creating interference patterns from multiple reflections of light.

FIG. 9 shows a membrane resonator chip 900 of the membrane resonator assembly 810 containing the membrane resonator 910. In an embodiment the membrane resonator is formed by a trampoline structure formed by the SiN membrane 910 suspended within the membrane resonator chip 900.

FIG. 10 show the membrane resonator 910. In an alternate embodiment the resonator membrane is formed by deposition of a material such as Gold Palladium (Au-Pd) on top of the SiN membrane rather than a Ti metasurface on the SiN membrane. The deposition on a front surface can be positioned in the circular pattern 1000 in the center of the trampoline 910 structure for optimal absorption. The circular pattern 1000 is provided for alignment with the optical fiber with a non-coated portion of the resonator so that there is less absorption of the laser light. This decreases the readout noise. Further deposition on the fixed ends of the resonator (the part of the trampoline connecting to the Si frame) would increase the damping. In an embodiment, a thin layer of sputtered Au-Pd is deposited on a front surface of the membrane to enable broadband 50% light absorption.

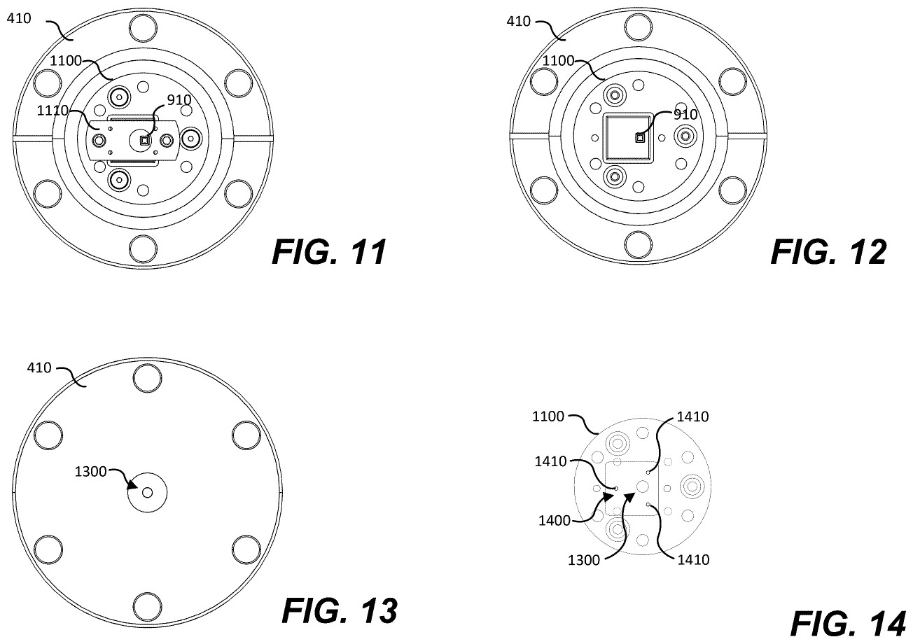

FIG. 11 shows the flange 410 providing an optical fiber feedthrough to the resonator 910. The resonator chip 900 is retained by a mounting top plate 1110 within a mounting bottom plate 1100 contained by the flange 410 position in the interior of the vacuum chamber 310. The mounting top plate 1110 is a flexible material, enabling a low mounting force to not create excessive stress on the membrane chip. FIG. 12 shows the flange 410 providing an optical fiber feedthrough to the resonator 910 without a mounting top plate. FIG. 13 shows a bottom (external) view of the flange 410 with a feedthrough 1300 for receiving a physical contact (PC) ferrule providing an optical fibre 820. The structure formed by the PC ferrule and resonator chip provides a cavity of approximately 100 μm employed in a Fabry-Pérot interferometer (FPI).

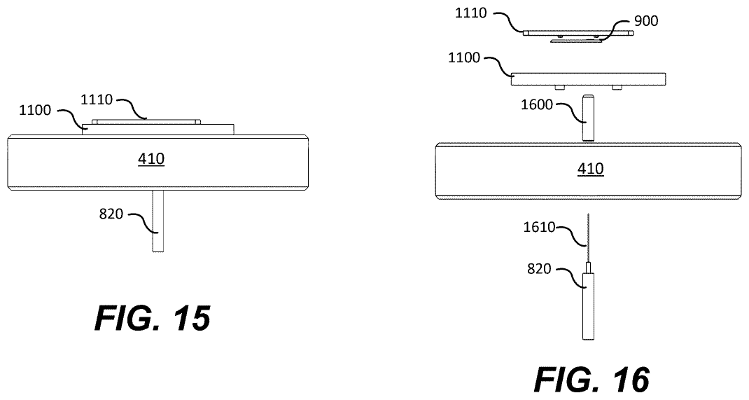

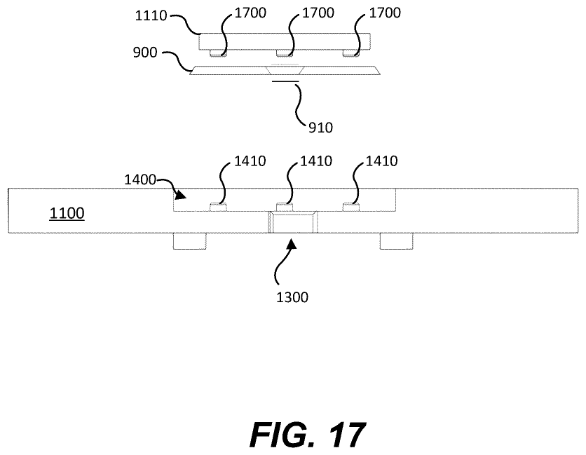

FIG. 14 shows the membrane bottom mounting plate 1100. The mounting plate contains a cavity 1400 for receiving the resonator 900. The cavity 1400 contains a plurality of pillars 1410 which align with top pillars of top mounting plate 1110 as shown in FIGS. 15 and 16. The pillars 1410, as further shown in FIG. 17, are precisely aligned to match the corresponding top plate 1110 pillars 1410, ensuring a stable fit that minimizes mounting contact with the resonator chip 900.

FIG. 15 shows a side view of an assembled configuration of the membrane mounting assembly 810 and FIG. 16 shows an expanded view of the membrane mounting 810. In addition to reducing the production cost, this optical fiber feedthrough also minimizes the overall dimension of the assembly. As opposed to most optical fiber feedthroughs available on the market, the present design features a PC tip 1600 positioned directly at the surface of the flange. An optical fiber 1610 extends from the optical fiber cable 820 through the PC tip 1600 to the Fabry-Pérot cavity, eliminating the need for addition optical fibers inside the vacuum chamber 310, thereby significantly reducing the total dimensions of the assembly.

The feedthrough consists of a PC ferrule mounted inside a flange 410, such as a CF40 flange, using high-temperature optical fiber epoxy (i.e., EPO-TEK® 353-ND). The leak rate of this optical fiber is negligible compared to the that of other components in the vacuum assembly (i.e. 4×10⁻⁷ Torr·L/s).

FIG. 17 shows an expanded side view, as shown from a top edge of the membrane mounting plate. The top plate 1110 and bottom plate 1100 couple together to contain membrane chip 900 containing the membrane resonator 910. A fixed-ended cantilever system is provided that secures the membrane carrier 900 with bolts (not shown).

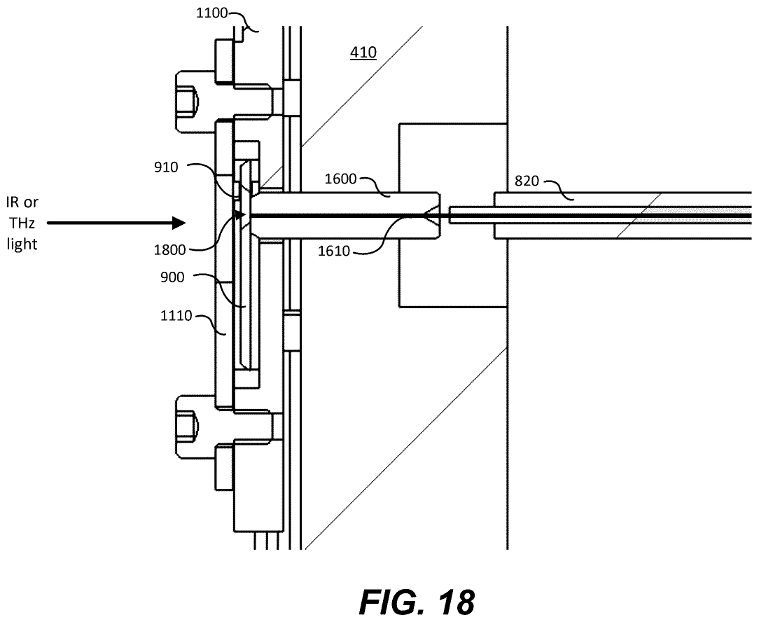

Rather than utilizing magnets, as described above, the particular mount includes pillars 1410, in this example three pillars although the number may vary, in the cavity 1400 in bottom plate 1100 that interface with pillars formed in the top plate 1110 that reduces the mounting area. The cantilever bolting system allows deformation of the top plate 1110, enabling a low mounting force to not to create excessive stress on the chip (or carrier), which would degrade performance. The mount is also designed to minimize air-trapping cavities, thereby enabling its use in high-vacuum applications. The mount of FIG. 17 enables an optical cavity, Fabry-Pérot on the order of 100 μm between the tip of the optical fiber 1610 and the membrane 910 as shown in regards to FIGS. 18-20.

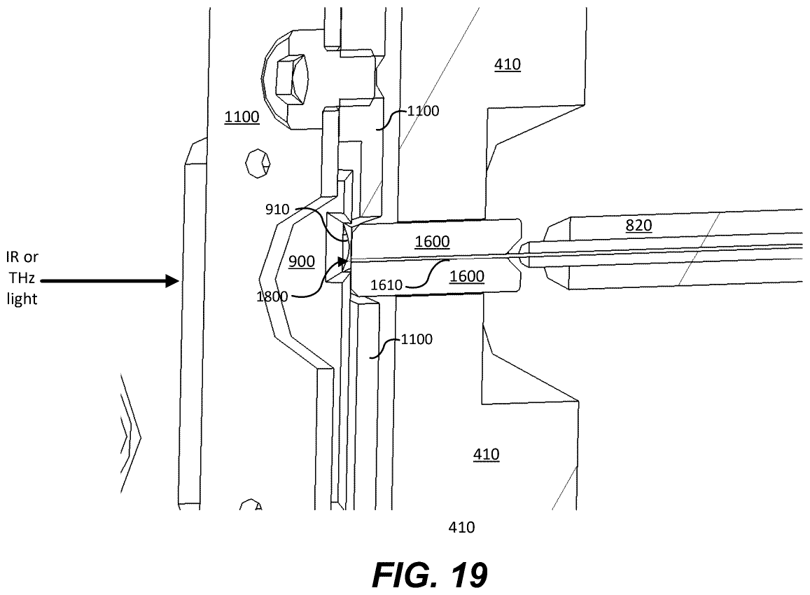

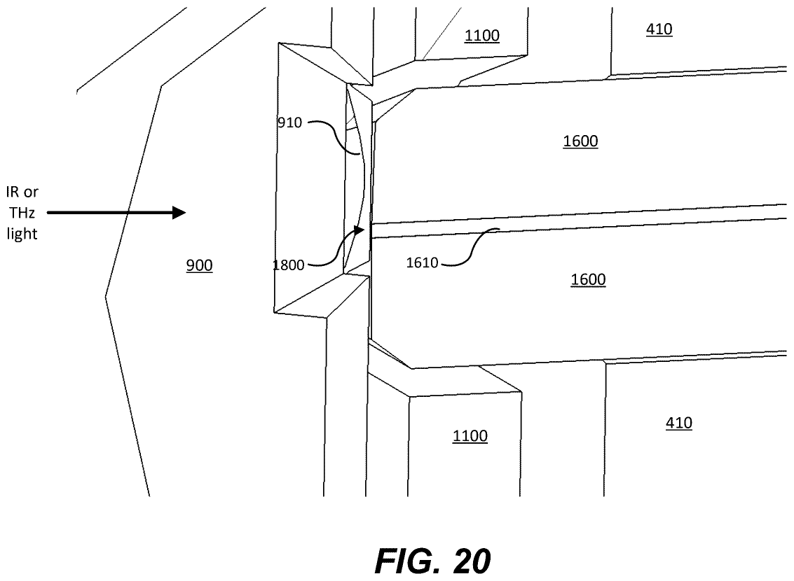

FIG. 18 shows a cross-sectional side profile of the membrane resonator assembly 810 and the flange 410. The Fabry-Pérot cavity 1800 is formed between the membrane resonator 910 of the membrane resonator chip 900 and the tip of the optical fiber 1610. The optical fiber 1610 interfaces with the membrane resonator 910 which is contained by top plate 1110 and bottom plate 1100. FIG. 19 shows a cross-sectional perspective view which highlights the three-dimensional arrangement of the resonator assembly, illustrating the spatial relationship between the membrane 910 and surrounding supporting elements. FIG. 20 shows an enlarged cross-sectional perspective view showing the interface between the membrane 910 and the optical fiber 1610 is clearly visible, demonstrating the precise alignment required for Fabry-Pérot cavity 1800 for effective resonance and accurate optical coupling.

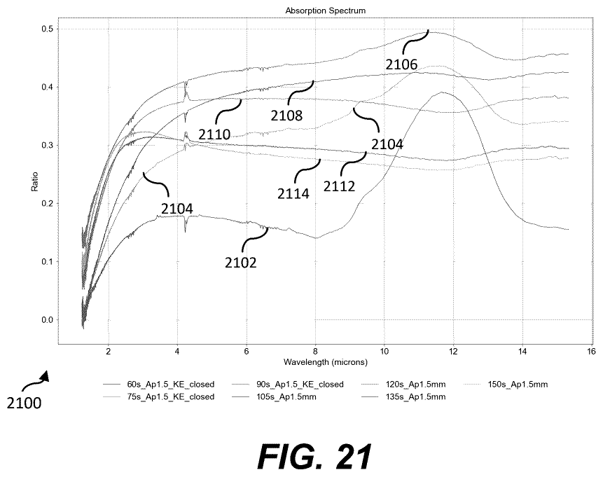

FIG. 21 shows a plot 2100 of optical absorption for Au-Pd on the membrane and for the optimal deposition time for the mechanical resonator. A deposition time of 60 seconds is shown by line 2102. A deposition time of 75 seconds is shown by line 2104. A deposition time of 90 seconds is shown by line 2106. A deposition time of 105 seconds is shown by line 2108. A deposition time of 120 seconds is shown by line 2110. A deposition time of 135 seconds is shown by line 2112. A deposition time of 150 seconds is shown by line 2114. From the plot optimal deposition time is provided between 90 and 105 seconds.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in FIGS. 1-21 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A high detectivity infrared and terahertz radiation sensor system comprising:
a vacuum chamber having a view port on a first surface;
a membrane resonator assembly mounted inside the vacuum chamber on an second surface opposite the first surface; and
an optical fiber entering the vacuum chamber via the second surface facing towards a front surface of the membrane resonator assembly, the optical fiber coupled to a laser interferometer;
wherein a rear surface of the membrane resonator assembly receives infrared or terahertz radiation incident light passing through the view port and is measured by the laser interferometer on the front surface of the membrane resonator assembly to determine the radiation intensity of the incident light.

2. The system of claim 1 wherein the membrane resonator assembly comprises an SiN membrane resonator.

3. The system of claim 2 wherein the membrane resonator assembly contains a trampoline structure resonator.

4. The system of claim 3 wherein the SiN membrane resonator has a layer of sputtered Au-Pd deposited thereon.

5. The system of claim 4 wherein the Au-Pd is deposited on the SiN membrane in a circular pattern.

6. The system of claim 5 wherein the SiN membrance comprises a metasurface having an array of cross absorber pattern on the membrane.

7. The system of claim 6 wherein the metasurface is formed by depositing titanium onto the SiN membrane resonator via electron beam evaporation through a shadow mask to form the metasurface.

8. The system of claim 1 where in the viewport is zinc selenide (ZnSe).

9. The system of claim 1 wherein the membrane resonator assembly is mounted inside the vacuum chamber by a flange coupled to the vacuum chamber, the membrane resonator assembly further comprising:
a membrane chip containing a membrane resonator thereon;
a bottom plate coupled having a cavity for receiving a membrane chip;
a top plate for containing the membrane chip within the bottom plate;
wherein the rear surface of the membrane resonator is directed towards the top plate and the front surface of the membrane is directed towards the bottom plate and the optical fiber.

10. The system of claim 9 where the bottom plate and the top plate have a plurality of corresponding pillars to retain the membrane carrier therein.

11. The system of claim 11 wherein 3 pillars are provided in the bottom plate and correspond to 3 pillars in the top plate.

12. The system of claim 10 wherein the top plate is flexible, enabling a low mounting force not to create excessive stress on the membrane chip.

13. The system of claim 10 wherein the optical fiber enters through an opening in the flange interfacing by a PC ferrule.

14. The system of claim 13 wherein the PC ferrule is retained by an a high-temperature optical fiber epoxy.

15. The system of claim 13 wherein the PC ferrule is glued in place to form a small Fabry-Pérot optical cavity when assembled with the membrane resonator cavity.

16. A method of an infrared and terahertz radiation sensing comprising:
actuating a membrane resonator by a piezo actuator coupled to the membrane resonator mounted inside a vacuum chamber having a view port onto a rear surface of the membrane resonator, the rear surface receiving an incident light source;
interrogating the membrane resonator by an optical fiber entering the vacuum chamber towards a front surface of the membrane resonator providing a fixed light source;
measuring the frequency of a received signal from fixed light source from the front surface of the membrane resonator;
measuring resonance frequency variation due to incoming radiation; and
estimating the power of the incident light source by tracking the variation of the membrane resonance frequency compared to a frequency reference.

17. The method of claim 16 further comprising, adjusting a piezo actuator coupled to the membrane resonator assembly to achieve a predetermined drive amplitude, and calibrating the sensor system by tracking the resonator's baseline frequency prior to exposure to the radiation beam.

18. The method of claim 16 further comprising, regulating the pressure inside the vacuum chamber to reduce damping and convective heat transfer, stabilizing the membrane resonator's temperature, and thereby minimizing noise for enhanced detection accuracy.

19. The method of claim 16 further comprising, determining a noise equivalent power of the sensor by measuring resonator frequency instability without incident radiation, dividing by the responsivity of the sensor, and thereby establishing the minimum detectable radiation power.

20. The method of claim 16 wherein the membrane resonator assembly and the optical fiber interface form a Fabry-Pérot optical cavity.
